(19) United States
(12) Patent Application Publication
(10) Pub. No.: US 2026/0236206 A1
(43) Pub. Date: Aug. 13, 2026

(54) PRINT CONTROL DEVICE, PRINT CONTROL METHOD, AND PRINTING SYSTEM

(71) Applicant: SEIKO EPSON CORPORATION, Tokyo (JP)

(72) Inventors: Takashi SERA, Shiojiri (JP); Masayuki KOBAYASHI, Fujimi-machi (JP); Katsuhito KITAHARA, Matsumoto (JP); Kohei YAMAMOTO, Matsumoto (JP)

(21) Appl. No.: 19/533,383

(22) Filed: Feb. 9, 2026

(30) Foreign Application Priority Data
Feb. 10, 2025 (JP) 2025-019839

(51) Int. Cl. G06F 3/12

(52) U.S. Cl. CPC G06F 3/125; G06F 3/1208; G06F 3/1256; G06F 3/1288

(57) ABSTRACT

A print control device includes an image acquisition section that acquires image data to be printed from a terminal device, an image division section that, when a size of an image indicated by the image data is larger than a size of a print area in one page of a print medium, divides the image into a plurality of divided images based on the size of the print area, and a print instruction transmitting section that generates print data for disposing the plurality of divided images in a plurality of the print areas, respectively, for printing and transmits an instruction to print the print data to a printing device.

The present application is based on, and claims priority from JP Application Serial Number 2025-019839, filed February 10, 2025, the disclosure of which is hereby incorporated by reference herein in its entirety.

### BACKGROUND

### 1. Technical Field

The present disclosure relates to a print control device, a print control method, and a printing system.

### 2. Related Art

In the related art, a chat service provided in an SNS or the like is known. For example, JP-A-2019-50552 discloses an example in which image data is printed by a multifunction device through interactions with a chat bot.

An aspect ratio of an image indicated by image data posted in a chat room may or may not be suitable for a print medium. For example, an image indicating a chat history in a chat application may be an image that is extremely long in a vertical direction. In addition, there are also images that are extremely long in a horizontal direction. When this image is printed, in the related art, a configuration is adopted in which the image is reduced so as to fit within a print area of one page of a print medium and then printed. However, the printed matter that has been reduced in size may be difficult for a user to view.

### SUMMARY

According to an aspect of the present disclosure, there is provided a print control device including: an image acquisition section that acquires image data to be printed from a terminal device; an image division section that, when a size of an image indicated by the image data is larger than a size of a print area in one page of a print medium, divides the image into a plurality of divided images based on the size of the print area; and a print instruction transmitting section that generates print data for disposing the plurality of divided images in a plurality of the print areas, respectively, for printing and transmits an instruction to print the print data to a printing device.

According to another aspect of the present disclosure, there is provided a print control method executed in a print control device, the print control method including: causing an image acquisition section to acquire image data to be printed from a terminal device; causing, when a size of an image indicated by the image data is larger than a size of a print area in one page of a print medium, an image division section to divide the image into a plurality of divided images based on the size of the print area; and causing a print instruction transmitting section to generate print data for disposing the plurality of divided images in a plurality of the print areas, respectively, for printing and to transmit an instruction to print the print data to a printing device.

According to still another aspect of the present disclosure, there is provided a printing system including a print control device and a printing device, in which the print control device includes an image acquisition section that acquires image data to be printed from a terminal device, an image division section that, when a size of an image indicated by the image data is larger than a size of a print area in one page of a print medium, divides the image into a plurality of divided images based on the size of the print area, and a print instruction transmitting section that generates print data for disposing the plurality of divided images in a plurality of the print areas, respectively, for printing and transmits an instruction to print the print data to the printing device, and the printing device performs printing based on the print data.

### BRIEF DESCRIPTION OF THE DRAWINGS

FIG. 1 is a block diagram illustrating a configuration of a printing system.

FIG. 2 is a view illustrating a display example of a chat room.

FIG. 3 is a view illustrating a display example of the chat room.

FIG. 4 is a view illustrating a display example of the chat room.

FIG. 5 is a view illustrating a display example of the chat room.

FIG. 6 is a sequence diagram illustrating a printing sequence.

FIG. 7 is a flowchart illustrating a division determination process.

FIG. 8 is a schematic view illustrating an example of division.

FIG. 9 is a schematic view illustrating an example of division.

FIG. 10 is a view illustrating a display example of a chat room.

FIG. 11 is a schematic view illustrating an example of division.

FIG. 12 is a schematic view illustrating an example of division.

### DESCRIPTION OF EMBODIMENTS

Here, embodiments of the present disclosure will be described in the following order.

1 Configuration of Printing System:

1-1 Configuration of Printing Device:

1-2 Configuration of Print Control Device:

2 Printing Sequence:

3 Other Embodiments:

### 1 Configuration of Printing System:

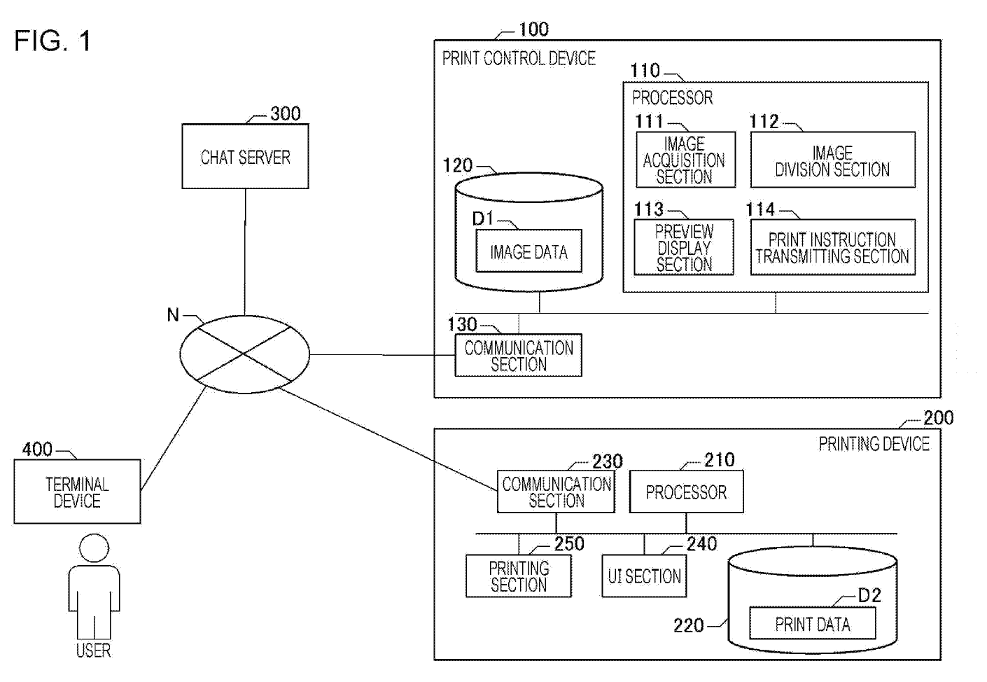

FIG. 1 is a block diagram illustrating a configuration of a printing system according to an embodiment of the present disclosure. The printing system includes a print control device 100 and a printing device 200. The print control device 100 and the printing device 200 can communicate with each other via a network N. Further, the print control device 100 can communicate with a chat server 300 via the network N. The chat server 300 is a server that provides a chat service in which a message is exchanged with a partner in a conversation format. A user of the chat service installs an application (chat application) for using the chat service on a terminal device 400 owned by the user and creates a user account for the chat service. The chat application is executed such that the terminal device 400 communicates with the chat server 300 via the network N.

The terminal device 400 is a device that can execute the chat application, and it may be assumed that the terminal device 400 is, for example, a smartphone, a tablet, or a PC. The terminal device 400 is provided with a camera, a communication section, a touch panel display, and a storage medium which are not illustrated.

When the user of the terminal device 400 approves an account of a chat bot that performs processes preset by a developer of the print control device 100 as a chat partner in the chat application, the user can exchange messages with the chat bot to use a chat printing service provided by the print control device 100. In the chat printing service, the user registers the printing device 200 to be used for printing in advance. The chat printing service enables the user to print an image to be printed using the registered printing device 200 through interactions with the chat bot in the chat application.

The terminal device 400 has a screenshot function of saving the entire screen displayed on a touch panel display as an image file in response to a predetermined screenshot operation on the touch panel display.

Further, in the present embodiment, the chat application has a function of saving a chat history as an image file. In addition, the chat history may be a long history that is not displayed on the screen of the touch panel display of the terminal device 400 at once, that is, that is so long that it cannot be viewed without scrolling to change a display range. The use of the above-described function of the chat application makes it possible for the user to save the chat history, which is too long to be displayed on the screen at once, as one image file in the terminal device 400. Furthermore, in the present specification, an image indicating the chat history that is too long to be displayed on the screen at once is also referred to as a screenshot image.

The user of the terminal device 400 may take a screenshot of, for example, search results on the Internet, the chat history of the chat application, or the like as a memorandum, save the screenshot, and print the saved screenshot image using the chat printing service. In addition, the user may print a screenshot image that is extremely long in the vertical direction such as the chat history described above. When this image is printed, in the related art, a configuration is adopted in which the image is reduced so as to fit within a print area of one page of a print medium and then printed. However, the printed matter that has been reduced in size may be difficult for the user to view, for example, because the characters and the like are small. When image data indicating an extremely elongated image is configured as one image file, it is desired to obtain a printed matter that is easier for the user to view than the printed matter obtained by reducing the image so as to fit within the print area and printing the reduced image as in the related art. Hereinafter, the configuration and processing content of the printing system for implementing the function of obtaining the printed matter that is easy to view even when an extremely elongated image is used will be described.

### 1-1 Configuration of Printing Device:

The printing device 200 includes a processor 210, a storage medium 220, a communication section 230, a UI section 240, and a printing section 250. The processor 210 includes a CPU, a ROM, a RAM, and the like (not illustrated) and executes a control program stored in the storage medium 220 to control each section of the printing device 200. In addition, the processor 210 may be configured by a single chip or a plurality of chips, or may be configured as an SoC together with various functional blocks for operating the printing device 200. Further, for example, an ASIC may be adopted instead of the CPU, or a configuration may be adopted in which the CPU and the ASIC cooperate with each other. When each device in the present embodiment includes a processor, the processor can be implemented in various aspects like the processor 210.

Various programs and control data executed by the processor 210 are stored in the storage medium 220. Further, print data D2 transmitted from the terminal device 400 is stored during the operation of the printing system. The communication section 230 includes a circuit used for wired or wireless communication with other devices according to various communication protocols. In the present embodiment, the printing device 200 can communicate with the print control device 100 via the network N using the communication section 230. The UI section 240 includes a touch panel display, keys, and the like for displaying various types of information to the user and for inputting the operation of the user.

The printing section 250 includes an actuator, a driving component, a mechanical component, various sensors, and the like for ejecting ink to a print medium to perform printing. The sensors for detecting the state of the printing device 200 include, for example, a sensor that detects the type of the print medium, such as the size of the print medium, set in a paper feeding section, a sensor that detects the remaining quantity of print media, a sensor that detects a jam in a transport path of the print medium, a sensor that detects the remaining amount of ink, and the like. The processor 210 controls the printing section 250 based on the print data such that printing is executed. Further, in the present embodiment, the printing section 250 that performs printing using an ink jet method is assumed. However, the printing method is not limited thereto.

When receiving the print data D2 from the print control device 100, the processor 210 controls the printing section 250 based on the print data D2 such that printing is executed. Further, the processor 210 transmits information indicating the progress and success or failure of a print job to the print control device 100 in response to an inquiry from the print control device 100. In addition, the processor 210 acquires the state of the printing device 200 based on the outputs of the sensors of the printing section 250 and transmits information indicating the state of the printing device 200 in response to an inquiry from the print control device 100.

### 1-2 Configuration of Print Control Device:

In the present embodiment, the print control device 100 is a server for implementing the chat printing function via the chat server 300. The print control device 100 may be configured by a plurality of servers. The print control device 100 includes a processor 110, a storage medium 120, and a communication section 130. The processor 110 includes a CPU, a ROM, a RAM, and the like and can execute various programs stored in the ROM or the storage medium 220 using the CPU. The communication section 130 is a communication interface for communicating with other devices. The print control device 100 can communicate with other devices connected to the network N using the communication section 130.

Image data D1 is stored in the storage medium 120 during the operation of the printing system. The image data D1 is image data that has been selected as the image to be printed by chat printing by the user using the chat application and then transmitted from the terminal device 400. One piece of image data D1 is configured as one image file. The image file is a file indicating that a file extension is an image.

The processor 110 executes a print control program (not illustrated) for implementing the chat printing function to function as an image acquisition section 111, an image division section 112, and a print instruction transmitting section 114.

The image acquisition section 111 is a function of acquiring image data to be printed from the terminal device 400. In the present embodiment, when the user starts the chat application in the terminal device 400, selects an image to be printed from an image list stored in the terminal device 400, and issues a transmission instruction, the processor 110 acquires image data indicating the image selected as a print target from the list by the user, using the image acquisition section 111.

The image division section 112 is a function of, when the size of the image indicated by the image data is larger than the size of the print area in one page of a print medium, dividing the image into a plurality of divided images based on the size of the print area. The print area is predetermined as an area in which the image to be printed can be disposed in the print medium. The processor 110 acquires the size of the image when the image is printed based on the numbers of pixels in the vertical and horizontal directions of the image and print resolution. When the size of the image is larger than the size of one print area, the processor 110 divides a portion larger than the print area into portions that fit within the print area. For the portion larger than the print area, when the size of the portion is larger than the size of one print area, the portion is divided in the same manner as described above. This division process is performed one or more times such that each of the divided images after the division has a size that fits within one print area.

The print instruction transmitting section 114 has a function that generates print data for disposing a plurality of divided images in a plurality of print areas, respectively, and for printing the divided images and transmits an instruction to print the print data to the printing device 200. This configuration of the print control device 100 makes it possible to obtain a printed matter that is easier for the user to view than the printed matter obtained by reducing the image so as to fit within the print area and printing the reduced image as in the related art.

In addition, the processor 110 may function as a preview display section 113 that generates a preview image, in which a plurality of divided images have been disposed in a plurality of print areas, respectively, and displays the preview image on the screen of the chat application in the terminal device. The processor 110 may be configured to transmit an instruction to print the print data to the printing device 200, using the print instruction transmitting section 114, when the print instruction is acquired from the terminal device 400 after the preview image is displayed on the screen of the chat application. This configuration enables the user to check the preview image on the screen of the chat application and to input a print instruction from the screen.

### 2 Printing Sequence:

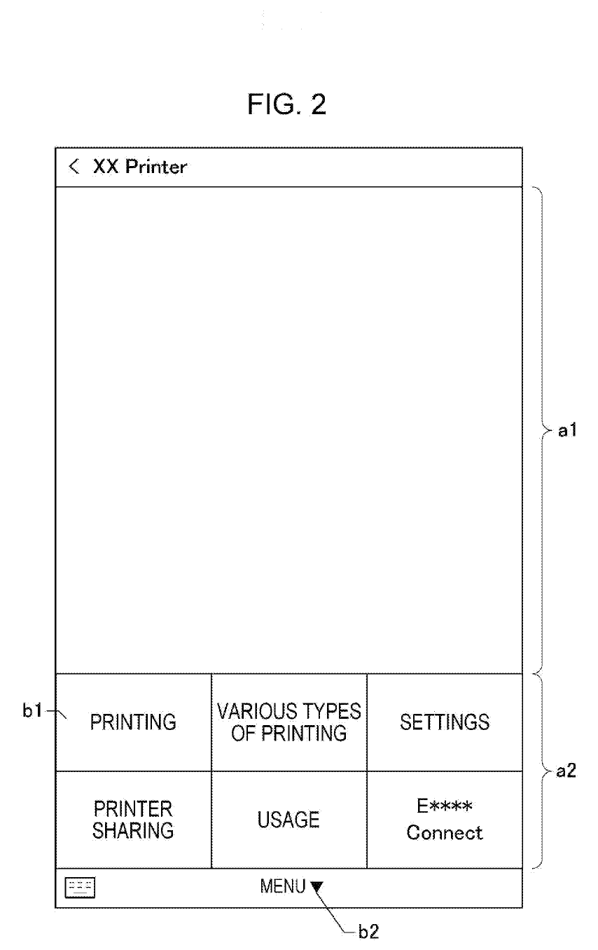

FIG. 2 is a view illustrating a display example of a chat room between an account "XX Printer" of the chat bot of the print control device 100 and an account of a user who causes the printing device 200 to execute printing using the printing system, which is displayed on the terminal device 400 used by the user.

When the user operates the terminal device 400 to start the chat application and to open the chat room with the account of the chat bot of the print control device 100, the chat room illustrated in FIG. 2 is displayed on the terminal device 400. As illustrated in FIG. 2, the chat room includes a menu portion a2 and a chat portion a1. In the chat portion a1, messages exchanged in a conversation format with the account of the print control device 100 are displayed in time series. A newer message is displayed lower in the chat portion a1. When a new message is input, the chat history up to that point in time is moved to the upper side of the chat portion a1 and displayed. The old messages that cannot be displayed within the range of the chat portion a1 are not displayed. When the user swipes the chat portion a1 in a direction from the top to the bottom of the screen, the old messages outside the display range can also be displayed.

The menu portion a2 is configured to include a plurality of menu buttons for using various functions related to chat printing which are provided by the print control device 100. The menu portion a2 includes a print button b1 for executing printing according to the guidance for each of the above-described print menus. In order to tap the print button b1 to perform printing according to the guidance, the user registers the printing device 200 to be used for printing by the user in advance. In addition, a button b2 is for turning on/off the display of the menu portion a2.

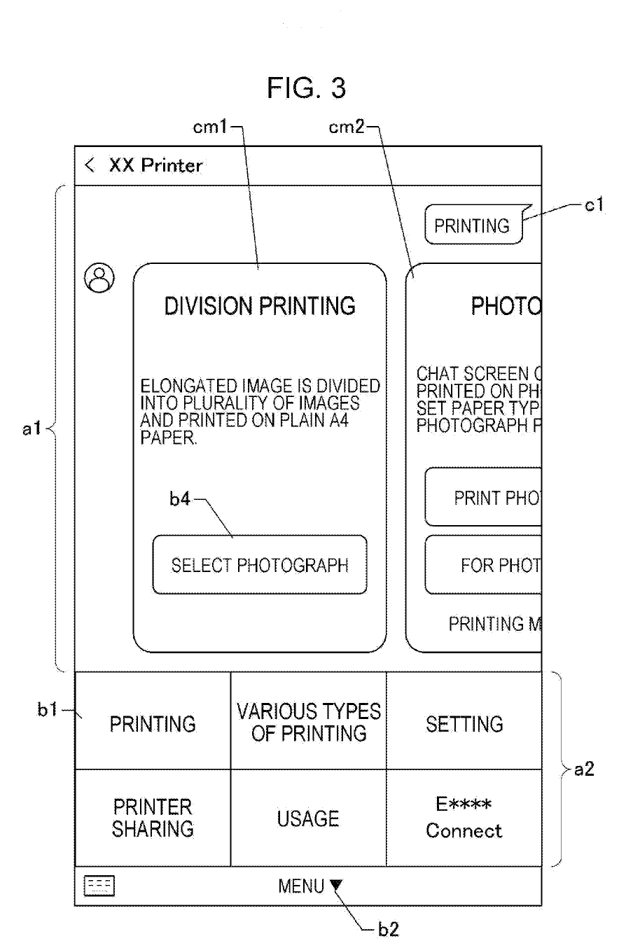

When the user selects the print button b1, the terminal device 400 notifies the print control device 100 that the print button b1 has been selected via the chat server 300. Upon receiving the notification, the processor 110 of the print control device 100 transmits an instruction to display the print menu to the terminal device 400 via the chat server 300. FIG. 3 is a view illustrating a display example of the print menu displayed on the display of the terminal device 400 by the terminal device 400 when the instruction to display the print menu is received.

As illustrated in FIG. 3, the terminal device 400 displays a message c1 indicating that the user has selected the print button b1 in the chat portion a1 and then displays cm1 and cm2 indicating print menus in the chat portion a1. The display range of the print menu portions, such as cm1 and cm2, in the chat portion a1 is changed by swiping in the left-right direction of the screen. FIG. 3 illustrates an example in which the first menu portion cm1 and a part of the second menu portion cm2 are displayed.

In the present embodiment, a first menu is a print menu used when an elongated image is divided into a plurality of images and printed on plain A4 paper. A second menu is a print menu used when an image is printed on photo paper. The print menu may include various other menus, and the illustration and description thereof will be omitted.

The first menu portion cm1 includes a description of a function that can be executed by selecting the first menu and a button b4 for proceeding with printing by the first menu according to the guidance. When the user selects the button b4, the terminal device 400 transmits information indicating that the selected print menu is the first menu to the print control device 100 via the chat server 300. The processor 110 of the print control device 100 acquires information indicating that the first menu has been selected.

The processor 110 performs image division using the function of the image division section 112 when determining that the image is an object to be subjected to division printing. This configuration makes it possible for the processor 110 to divide and print the image to be subjected to the division printing. Specifically, in the present embodiment, it is determined that the image is the object to be subjected to the division printing when both of the following two conditions are satisfied. A first condition is that an instruction to perform division printing on image data is acquired from the user of the terminal device. In the present embodiment, the first condition is that the processor 110 acquires the information indicating that the user has selected the first menu, as described above. A second condition is a condition indicating that the size of the image is larger than the size of the print area. In the present embodiment, the second condition is that the length of a short side of an image is equal to or shorter than the length of a short side of the print area and the length of a long side of the image is larger than the length of a long side of the print area. With the above configuration, in the present embodiment, when the user selects the first menu and the above-described condition related to the size of the image is satisfied, the processor 110 can divide the image.

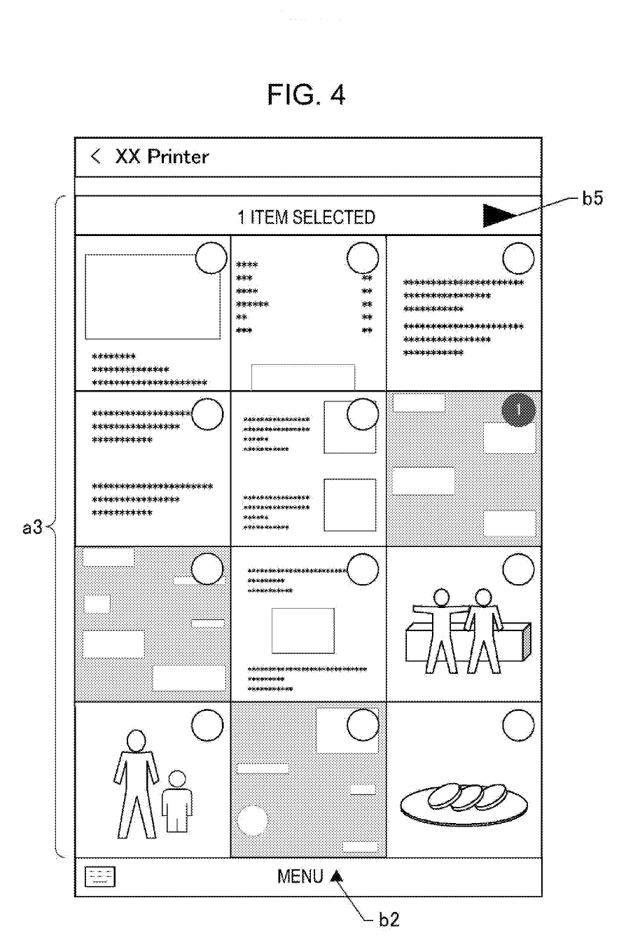

The description returns to the sequence after the selection of the button b4 in the first menu portion cm1 illustrated in FIG. 3. When acquiring the information indicating that the first menu has been selected, the processor 110 of the print control device 100 transmits an image list display instruction to the terminal device 400 via the chat server 300 using the function of the image acquisition section 111. The image list display instruction is an instruction to display the image list stored in the terminal device 400. The display of the image list is performed to allow the user to select the image to be printed. Upon receiving the image list display instruction, for example, the terminal device 400 displays an image list display portion a3 in the chat room as illustrated in FIG. 4.

FIG. 4 illustrates an example in which thumbnails of the images stored in the storage medium of the terminal device 400 are displayed side by side in the image list display portion a3. In addition, the images displayed in the image list display portion a3 are images of files with an extension indicating images and include various images such as screenshot images and images captured by the camera included in the terminal device 400.

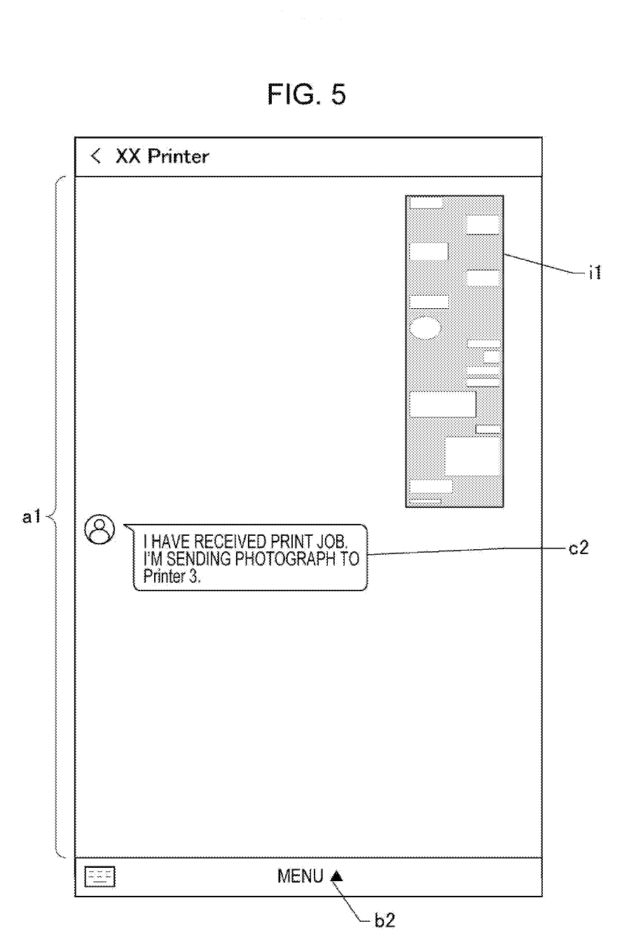

In the example illustrated in FIG. 4, one of the thumbnails displayed side by side in the image list display portion a3 is selected. When a send button b5 is tapped in a state in which one thumbnail is selected as described above, the terminal device 400 displays the selected image i1 in the chat portion a1 as illustrated in FIG. 5. Further, the terminal device 400 transmits image data D1 corresponding to the selected thumbnail to the print control device 100.

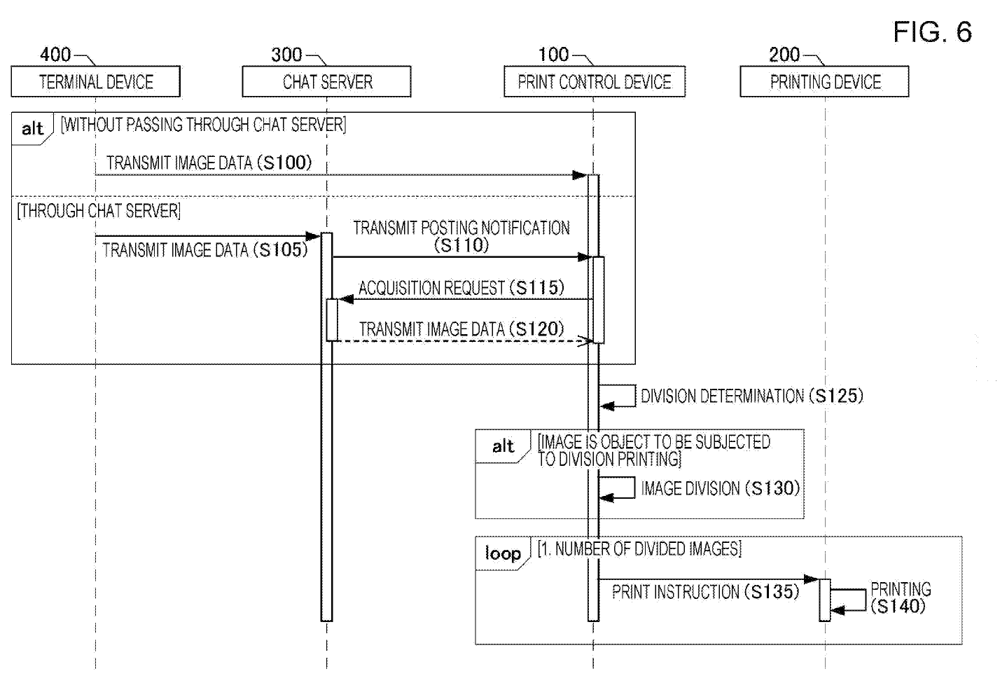

FIG. 6 is a view illustrating a sequence after the process in which the terminal device 400 transmits the image data D1 to the print control device 100. Steps S105 to S120 show a sequence when the image data is transmitted to the print control device 100 through the chat server 300. That is, the terminal device 400 transmits the image data selected by the user to the chat server 300 (Step S105). When receiving the image data, the chat server 300 transmits a posting notification indicating that the image has been posted to the chat room to the print control device 100 (Step S110). The processor 110 of the print control device 100 transmits a request to acquire the image data to the chat server 300, using the function of the image acquisition section 111, in response to the posting notification in Step S110 (Step S115), and the chat server 300 transmits the image data to the print control device 100 in response to the acquisition request (Step S120). As a result, the processor 110 of the print control device 100 acquires the image data using the function of the image acquisition section 111.

In addition, the image data may be transmitted to the print control device 100 without passing through the chat server 300 as illustrated in Step S100. The image list display portion a3 illustrated in FIG. 4 may be configured to be displayed by, for example, an internal browser of the chat application. In this case, when an image is selected and the send button is selected in the browser, the terminal device 400 can transmit image data indicating the selected image to the print control device 100 without passing through the chat server 300.

The following configuration may be adopted. When receiving the image data, the processor 110 of the print control device 100 transmits a message indicating that the printing of the received image will be executed to the chat server 300. As a result, a message, such as c2 illustrated in FIG. 5, is displayed in the chat room.

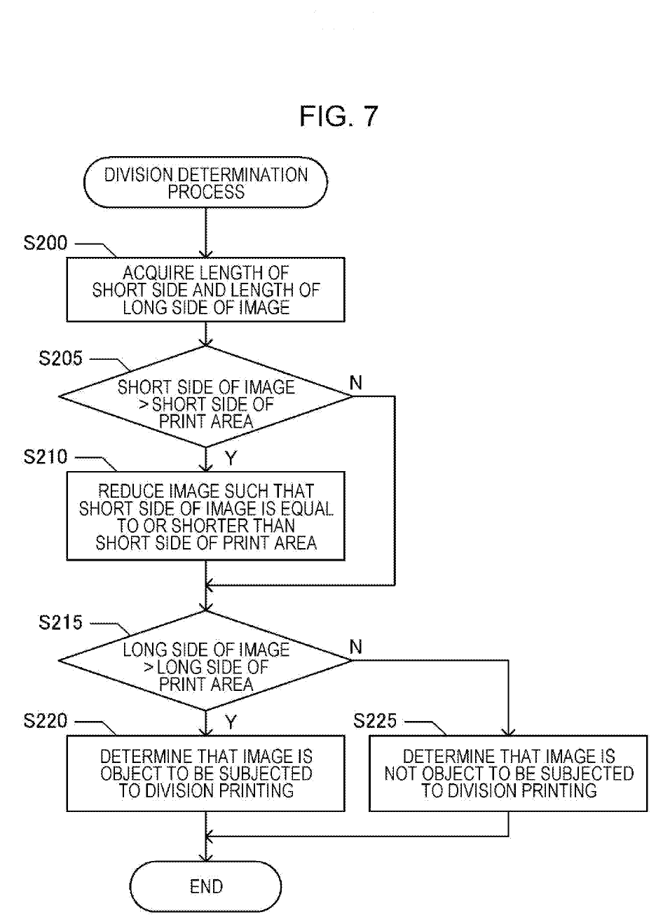

When acquiring the image data in Step S120 of FIG. 6, the processor 110 of the print control device 100 performs a division determination process using the function of the image division section 112 (Step S125). The division determination process is a process of determining whether or not the image indicated by the image data acquired in Step S120 is an object to be subjected to division printing. FIG. 7 is a flowchart illustrating the division determination process.

In the division determination process, the processor 110 acquires the length of the short side and the length of the long side of the image (Step S200). That is, the processor 110 analyzes the image data to acquire the number of pixels in the vertical direction, that is, a height direction, and the number of pixels in the horizontal direction, that is, a width direction of the image. The image may be a vertically long image or a horizontally long image. However, in the present embodiment, when the first menu is selected, the image is disposed in the print area such that the long side of the image is parallel to the long side of the print area to generate print data.

The processor 110 treats the shorter of the height and width of the image as the short side and the longer of the height and width of the image as the long side. Furthermore, the processor 110 acquires the print resolution (dpi) when printing an image in the first menu. The print resolution in the first menu may be a predetermined value or a value set by the user. The processor 110 calculates the length of the long side and the length of the short side of the image when the image is printed, based on the number of pixels of the long side and the number of pixels of the short side of the image and the print resolution.

Then, the processor 110 determines whether or not the length of the short side of the image is longer than the length of the short side of the print area (Step S205). The processor 110 acquires the size of the print medium used in the first menu, and the length of the short side and the length of the long side of the print area in the print medium with the size. The size of the print medium used for printing in the first menu is A4 in the present embodiment. The print area is an area excluding the margins provided in both end portions of the print medium in the vertical direction and both end portions thereof in the horizontal direction. When the margin is not 0, the size of the print area is smaller than the size of the print medium. In addition, the margin may be 0. In this case, the size of the print area is equal to the size of the print medium. In Step S205, the processor 110 compares the length of the short side of the image with the length of the short side of the print area and determines whether or not the former is shorter than the latter.

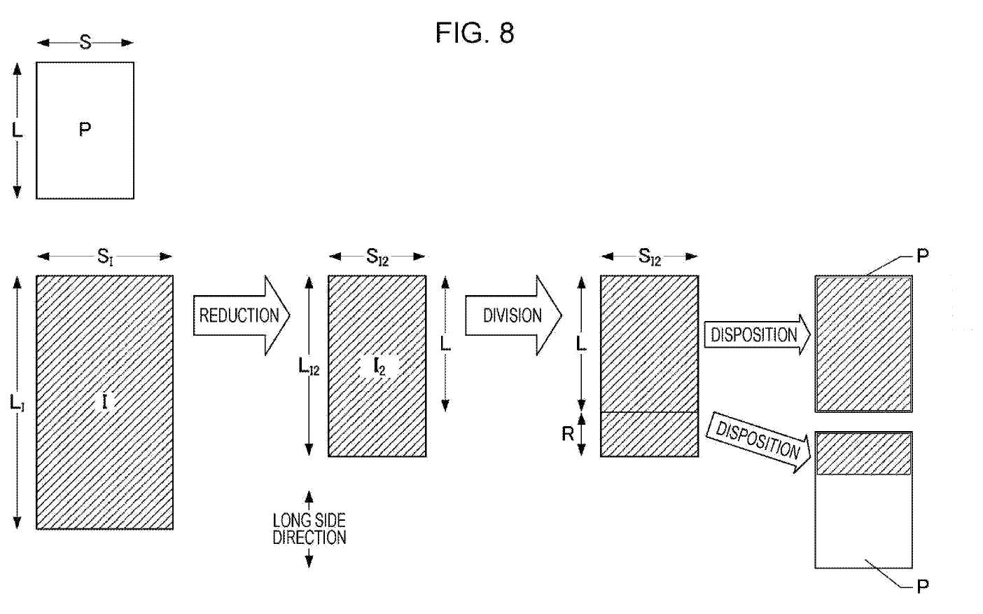

In Step S205, when it is determined that the length of the short side of the image is longer than the length of the short side of the print area, the processor 110 reduces the image such that the length of the short side of the image is equal to or shorter than the length of the short side of the print area (Step S210) and proceeds to the process in Step S215. FIG. 8 illustrates an example in which a length S_{I} of a short side of an image I is longer than a length S of a short side of a print area P. In this case, the processor 110 reduces the image I, for example, at a reduction ratio where S_{I} is the maximum value that does not exceed S and acquires an image I₂. For example, the image I is reduced at a reduction ratio where S_{I} is equal to S.

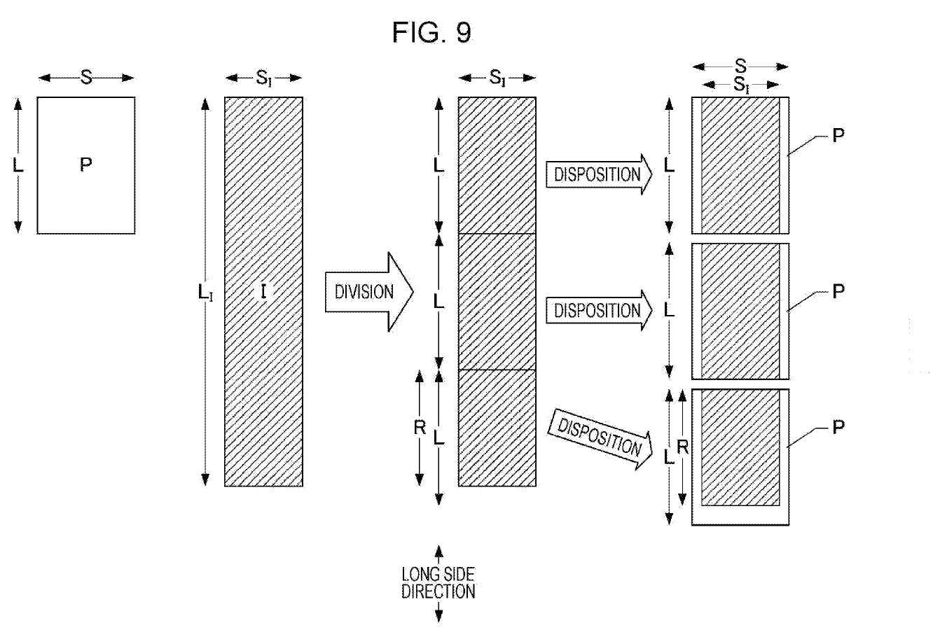

When it is not determined that the length of the short side of the image is longer than the length of the short side of the print area in Step S205 of FIG. 7, the processor 110 skips Step S210 and proceeds to the process in Step S215. FIG. 9 illustrates an example in which the length S_{I} of the short side of the image I is shorter than the length S of the short side of the print area P.

After the Step S210 of FIG. 7 is executed or when it is not determined in the Step S205 that the length of the short side of the image is longer than the length of the short side of the print area, the processor 110 determines whether or not the length of the long side of the image is longer than the length of the long side of the print area (Step S215). In addition, the image in Step S215 is the reduced image when Step S210 is executed. Therefore, the short side of the image to be processed in Step S215 is shorter than the short side of the print area. When it is determined in Step S215 that the length of the long side of the image is longer than the length of the long side of the print area, the processor 110 determines that the image is an object to be subjected to the division printing (Step S220). When it is not determined in Step S215 that the length of the long side of the image is longer than the length of the long side of the print area, the processor 110 determines that the image is not the object to be subjected to the division printing (Step S225).

For example, in the case of the example illustrated in FIG. 8, since a length L_{I2}of a long side of the reduced image I₂ is longer than the length L of the long side of the print area P, the processor 110 determines that the image I₂ is the object to be subjected to the division printing. In addition, for example, in the case of the example illustrated in FIG. 9, since the length L_{I}of the long side of the image I is longer than the length L of the long side of the print area P, the processor 110 determines that the image I is the object to be subjected to the division printing.

The division determination process illustrated in FIG. 7 is performed in Step S125 of FIG. 6. Then, the processor 110 performs an image division process when the image is the object to be subjected to the division printing (Step S130). That is, the processor 110 divides the image in a long side direction to generate divided images. Further, the long side direction is a direction parallel to the long side of the image. Assuming that, when the length of the long side of the image is divided by the length L of the long side of the print area, the quotient is Q (Q is an integer equal to or greater than 1) and the remainder is R (R is a value equal to or greater than 0), the number of divided images X obtained by dividing the image is Q when R is 0 and is Q + 1 when R is greater than 0. In addition, in the present embodiment, when the remainder R is 0, the length of the long side of the divided image is L. Even when the remainder R is greater than 0, the length of the long side of each of the Q divided images from the start end of the image is L, and the length of the remaining one residual image in the long side direction is R (< L). When the image is reduced through Step S210 of FIG. 7, the reduced image is divided as described above. Further, in the example illustrated in FIG. 8, the quotient Q is 1, and the remainder R is greater than 0. In the example illustrated in FIG. 9, the quotient Q is 2, and the remainder R is greater than 0. Furthermore, when the image is not the object to be subject to the division printing, Step S130 in FIG. 6 is skipped.

Then, the processor 110 transmits a print instruction to the printing device 200 (Step S135). When the print instruction in Step S135 is received, the processor 210 of the printing device 200 executes printing based on the received print data (Step S140). The process in Steps S135 and S140 is executed once when it is determined in Step S125 that the image is not the object to be subjected to the division printing. When it is determined in Step S125 that the image is the object to be subjected to the division printing, the process in Steps S135 and S140 is repeated X times which is the number of divided images.

In Step S135, the processor 110 generates print data for disposing the image in the print area of plain A4 paper for printing by the printing device 200 and transmits a print instruction to print the print data on the plain A4 paper to the printing device 200. In Step S140, the processor 210 of the printing device 200 executes printing corresponding to one page on the plain A4 paper based on the received print data. Further, FIG. 8 illustrates the generation of print data in which two divided images are disposed in the print areas P of two pages, respectively. FIG. 9 illustrates the generation of print data in which three divided images are disposed in the print areas P of three pages, respectively. The print data is generated for each page, is transmitted to the printing device 200, and is then printed.

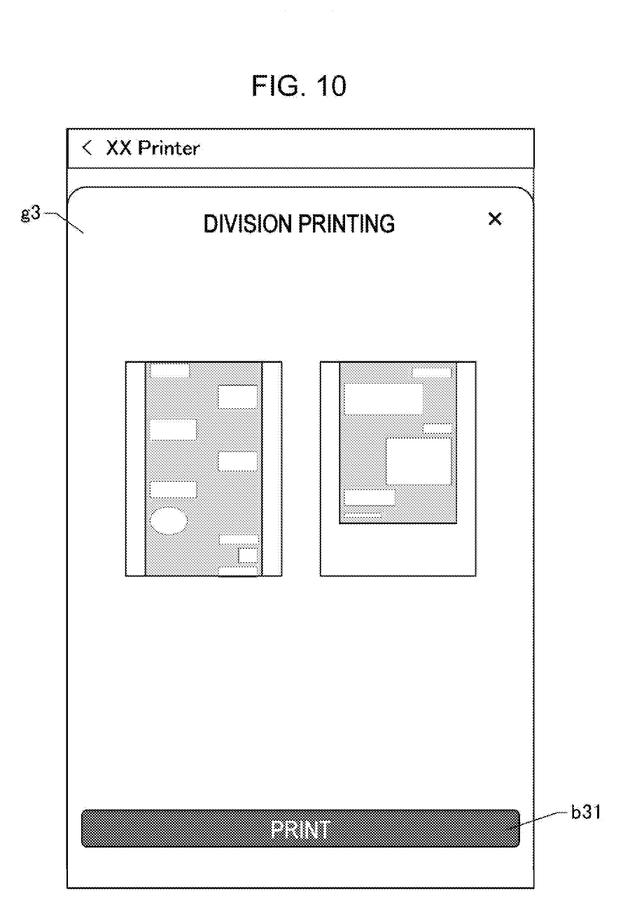

In addition, after Step S130 of FIG. 6 and before Step S135 is executed, the processor 110 may generate a preview image in which a plurality of divided images are disposed in a plurality of print areas, respectively, and display the preview image on the screen of the chat application in the terminal device 400, using the preview display section 113. For example, after the image i1 is displayed in the chat portion a1 as illustrated in FIG. 5, the print control device 100 may display a screen g3 on the browser of the chat application of the terminal device 400 as illustrated in FIG. 10. The screen g3 includes a preview image and a print instruction button b31. The print control device 100 may be configured to, when acquiring that the print instruction button b31 on the screen g3 has been selected, end the screen g3, display the message c2 illustrated in FIG. 5 in the chat portion a1, and execute the process after Step S135 in FIG. 6.

### 3 Other Embodiments:

The above-described embodiment is an example for implementing the present disclosure, and various other embodiments can be adopted. For example, the print control device may be configured by a plurality of devices. Further, one user may use a plurality of printing devices for the chat printing service.

The image selected in the first menu is not limited to the screenshot image and may be various images. In addition, the above-described image division printing is not limited to the application to the chat printing using the chat application and may be adopted in various other applications.

When the size of the image is larger than the size of the print area in one page of a print medium, the image division section may divide the image into a plurality of divided images based on the size of the print area. The image may be divided in the long side direction or may be divided in a short side direction. In the latter case, for example, a configuration may be adopted in which a portion of the image, which is larger than the short side of the print medium, in the short side direction is divided in the short side direction.

Further, in the above-described embodiment, the image is divided in the long side direction such that, when the remainder R is greater than 0, the length of the long side of each of the Q divided images from the start end of the image is L and the length of the remaining one residual image in the long side direction is R (< L). However, the present disclosure is not limited to this. For example, the image may be divided such that the length of each divided image in the long side direction is (L_{I}/(Q + 1)). In this case, the divided images obtained by dividing the image into (Q + 1) equal parts in the long side direction can be printed on (Q + 1) print media in the case of single-sided printing.

In the above-described embodiment, when both condition 1 and condition 2 are satisfied, it is determined that the image is the object to be subjected to the division printing. Condition 1 is that the image to be printed is selected in a state in which the first menu is selected by the user, and condition 2 is that the short side of the image is equal to or shorter than the short side of the print area and the long side of the image is longer than the long side of the print area as illustrated in FIG. 7. However, for example, when condition 2 is satisfied, the image may be automatically divided and printed, regardless of whether or not condition 1 is satisfied, that is, regardless of whether or not the first menu is selected. Alternatively, for example, both the preview image when the image satisfying condition 2 is not divided and is reduced and printed as in the related art and the preview image when the image is divided and printed as in the above-described embodiment may be presented, and the preview image selected by the user may be printed. In addition, as the condition for determining whether or not the image is the object to be subjected to the division printing based on the size of the image and the size of the print area, conditions other than the above-described condition 2 may be adopted.

The image acquisition section may acquire a plurality of pieces of image data to be printed. For example, a plurality of images may be selected from the image list illustrated in FIG. 4, and a plurality of pieces of image data may be transmitted to the print control device 100. In this case, the image division section may be configured to stitch the plurality of images indicated by the plurality of pieces of image data to each other along the short sides and divide the stitched image composed of the plurality of images after the stitching in the same manner as in the above-described embodiment.

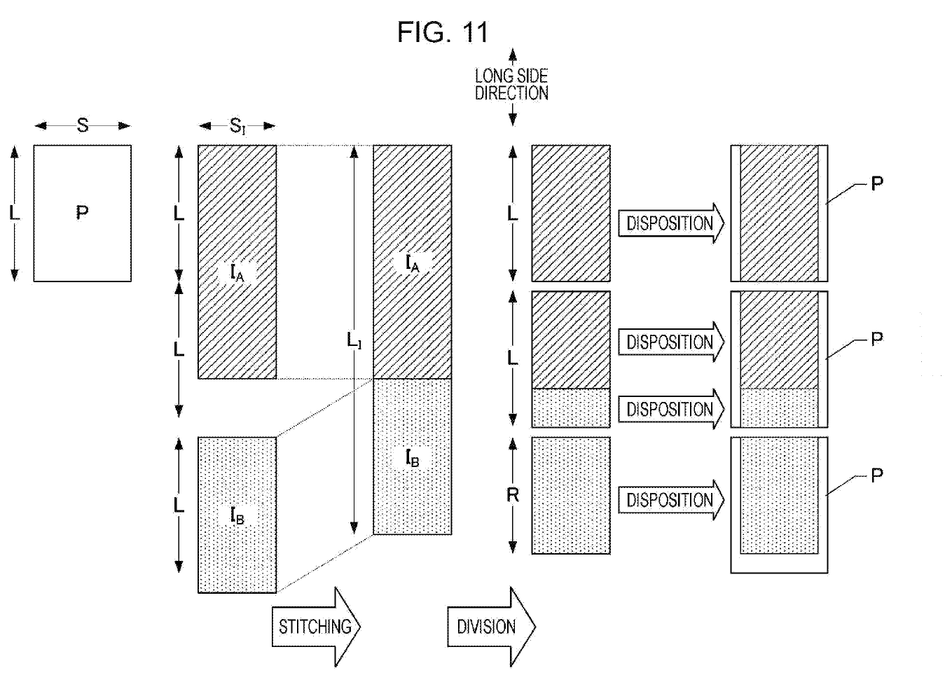

FIG. 11 illustrates an example in which two images I_{A} and I_{B} are stitched and then divided. As illustrated in this example, when a length L_{I} of a long side of a stitched image obtained by stitching the two images I_{A} and I_{B} is longer than the length L of the long side of the print area P, the stitched image may be configured to be divided into X divided images in the long side direction. Assuming that, when the length L_{I} of the long side of the stitched image is divided by the length L of the long side of the print area, the quotient is Q (Q is an integer equal to or greater than 1) and the remainder is R (R is a value equal to or greater than 0), X is Q when R is 0 and is Q + 1 when R is greater than 0. This configuration makes it possible to reduce the number of print media used, as compared to a case where the images are independently divided and disposed in the print areas, respectively, without being stitched to each other. For example, in the case of the example illustrated in FIG. 11, when two images are independently divided without being stitched to each other, the number of print media used is four in single-sided printing. However, when the images are stitched and divided, the number of print media used is three.

In addition, when the divided images are disposed in the print areas, respectively, text indicating which part number of which image before the stitching the divided image includes may also be disposed in the print area and then printed. For example, the file name of the image before the stitching and a value indicating the part number may be disposed and printed. This configuration enables the user to easily understand the content of the printed matter.

In addition, when the image acquisition section acquires a plurality of pieces of image data to be printed, a plurality of images indicated by the plurality of pieces of image data may be independently divided. Further, when residual images, each of which has a length less than L in the long side direction of the image, are generated by the division of each image and the sum of the lengths of the residual images in the long side direction is equal to or shorter than the length L of the long side of one print area, the residual images may be disposed in one print area. This will be described in detail. When the image acquisition section acquires a plurality of pieces of image data and attention is given to two of the plurality of pieces of image data, the images may be divided as follows and disposed in the print areas.

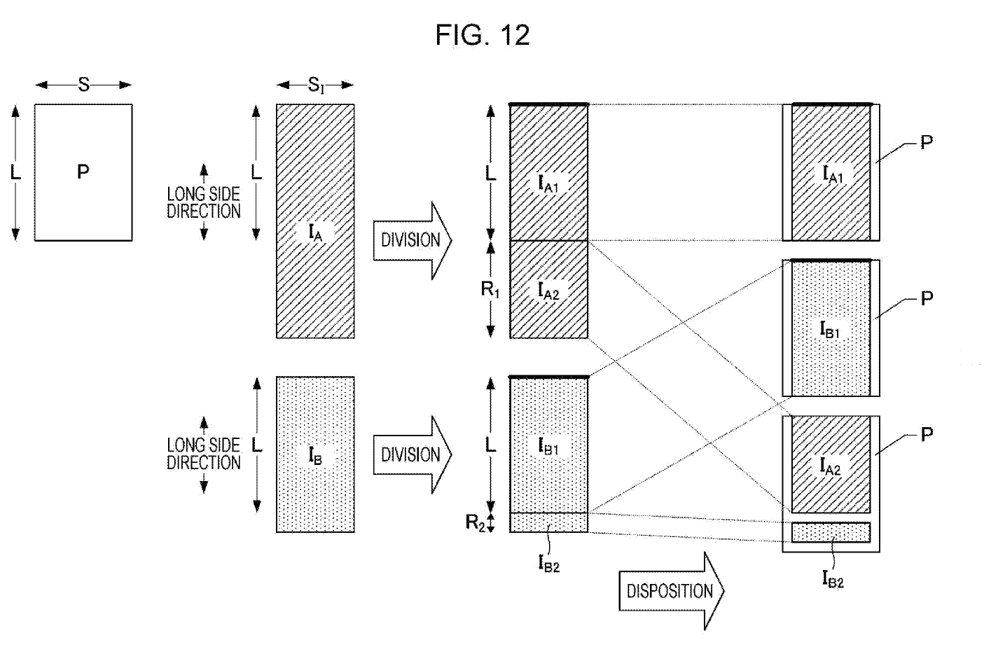

The two pieces of image data to be printed are referred to as first image data and second image data. It is assumed that, when the length of the long side of a first image indicated by the first image data is divided by the length L of the long side of the print area, the quotient is Q₁ (Q₁ is an integer equal to or greater than 1), and the remainder is R₁ (R₁ is a value equal to or greater than 0). In this case, the image division section may be configured to divide the first image into Q₁ first divided images, which have the length L in the long side direction, and one first residual image, which has the length R₁ in the long side direction, in the long side direction of the first image when R₁ is greater than 0. FIG. 12 illustrates an example in which a first image I_{A} is divided into one (= Q₁) first divided image I_{A1} having a length L and one first residual image I_{A2} having a length R₁. In addition, the long side direction of the first image is a direction parallel to the long side of the first image.

Further, it is assumed that, when the length of the long side of a second image indicated by the second image data is divided by the length L of the long side of the print area, the quotient is Q₂ (Q₂ is an integer equal to or greater than 1), and the remainder is R₂ (R₂ is a value equal to or greater than 0). In this case, the image division section is configured to divide the second image into Q₂ second divided images, which have the length L in the long side direction, and one second residual image, which has the length R₂ in the long side direction, in the long side direction of the second image when R₂ is greater than 0. FIG. 12 illustrates an example in which a second image I_{B} is divided into one (= Q₂) second divided image I_{B1} having the length L and one second residual image I_{B2} having the length R₂. The long side direction of the second image is a direction parallel to the long side of the second image.

The print instruction transmitting section generates print data for disposing the Q₁ first divided images in Q₁ print areas and disposing the Q₂ second divided images in Q₂ print areas for printing. Furthermore, when the sum of the length of the first residual image in the long side direction of the first image and the length of the second residual image in the long side direction of the second image is equal to or less than L, the print instruction transmitting section generates print data for disposing the first residual image and the second residual image in one print area for printing. Then, the print instruction transmitting section transmits an instruction to print the generated print data to the printing device.

In the example illustrated in FIG. 12, one (= Q₁) first divided image I_{A1} is disposed in one (= Q₁) print area P, and one (= Q₂) second divided image I_{B1} is disposed in one (= Q₂) print area P. Furthermore, FIG. 12 illustrates that, since the sum of the length R₁ of the first residual image I_{A2} in the long side direction and the length R₂ of the second residual image I_{B2} in the long side direction is less than L, the first residual image I_{A2} and the second residual image I_{B2} are disposed in one print area P.

This configuration makes it possible to dispose both the first image I_{A} and the second image I_{B} such that one end portion (represented by a thick black line) thereof in the long side direction is aligned with one end portion of the print area P in the long side direction and to print the images. When a plurality of images are stitched and then divided as illustrated in FIG. 11, one end portion of each of the second and subsequent images in the length direction is not necessarily aligned with one end portion of the print area P in the length direction. However, in the case of the example illustrated in FIG. 12, it is possible to dispose both the first image I_{A} and the second image I_{B} such that one end portion thereof in the long side direction is aligned with one end portion of the print area P in the long side direction and to print the images. Further, since the first residual image I_{A2} and the second residual image I_{B2} can be disposed in one print area (one print medium) and printed, it is possible to reduce the number of print media used, as compared to a case where these images are printed in separate print areas. In addition, when the first divided image, the second divided image, the first residual image, and the second residual image are disposed in the respective print areas, text indicating information indicating the number of the image in the original image before division, the file name and attribute information of the image before division, and the like may be disposed in the vicinity of each disposed image, and the images may be printed. This configuration enables the user to easily understand the content of the printed matter.

Further, in the above-described embodiment, the example has been described in which one print area is provided on one page of a print medium. However, two or more print areas may be provided on one page of a print medium. Even when two or more print areas are provided on one page of a print medium, division determination and division may be performed for each of the two or more print areas in the same manner as in the above-described embodiment. This configuration makes it possible to obtain a printed matter that is easier to view, as compared to a case where the images are reduced such that one image fits within each print area and are disposed.

Furthermore, the present disclosure can also be applied as a program executed by a computer and a print control method. Further, the printing system, the program, and the print control method described above may be implemented as a single device, may be implemented using components provided by a plurality of devices, and include various aspects. Further, the printing system, the program, and the print control method can be changed as appropriate. For example, parts of the printing system, the program, and the method are software or hardware. Further, the present disclosure is also established as a recording medium storing a program for controlling a system. Of course, the recording medium storing the program may be a magnetic recording medium or a semiconductor memory, and any recording medium developed in the future can be considered in exactly the same way.

What is claimed is:

1. A print control device comprising:
an image acquisition section that acquires image data to be printed from a terminal device;
an image division section that, when a size of an image indicated by the image data is larger than a size of a print area in one page of a print medium, divides the image into a plurality of divided images based on the size of the print area; and
a print instruction transmitting section that generates print data for disposing the plurality of divided images in a plurality of the print areas, respectively, for printing and transmits an instruction to print the print data to a printing device.

2. The print control device according to claim 1, wherein
the image division section divides the image when it is determined that the image is an object to be subjected to division printing.

3. The print control device according to claim 2, wherein
the image division section determines that the image is the object to be subjected to the division printing when a length of a short side of the image is equal to or shorter than a length of a short side of the print area and a length of a long side of the image is longer than a length of a long side of the print area.

4. The print control device according to claim 2, wherein
the image division section determines that the image is the object to be subjected to the division printing when an instruction to perform the division printing on the image data is acquired from a user of the terminal device.

5. The print control device according to claim 1, wherein
the image division section reduces the image such that a length of a short side of the image is equal to or shorter than a length of a short side of the print area when the length of the short side of the image is longer than the length of the short side of the print area, and divides the reduced image into X divided images in a long side direction when a length of a long side of the reduced image is longer than a length of a long side of the print area, and
assuming that, when the length of the long side of the reduced image is divided by the length of the long side of the print area, a quotient is Q, Q being an integer equal to or greater than 1, and a remainder is R, R being a value equal to or greater than 0, X is Q when R is 0 and is Q + 1 when R is greater than 0.

6. The print control device according to claim 1, wherein
the image acquisition section acquires a plurality of pieces of the image data to be printed,
the image division section stitches a plurality of the images indicated by the plurality of pieces of image data along short sides and divides a stitched image, which is composed of the plurality of images after the stitching, into X divided images in a long side direction when a length of a long side of the stitched image is longer than a length of a long side of the print area, and
assuming that, when the length of the long side of the stitched image is divided by the length of the long side of the print area, a quotient is Q, Q being an integer equal to or greater than 1, and a remainder is R, R being a value equal to or greater than 0, X is Q when R is 0 and is Q + 1 when R is greater than 0.

7. The print control device according to claim 1, wherein
the image acquisition section acquires first image data and second image data which are two pieces of image data to be printed,
assuming that, when a length of a long side of a first image indicated by the first image data is divided by a length L of a long side of the print area, a quotient is Q₁, Q₁ being an integer equal to or greater than 1, and a remainder is R₁, R₁ being a value equal to or greater than 0, the image division section divides the first image into Q₁ first divided images, each of which has a length of L, and one first residual image having a length of R₁ in a long side direction of the first image when R₁ is greater than 0,
assuming that, when a length of a long side of a second image indicated by the second image data is divided by the length L of the long side of the print area, a quotient is Q₂, Q₂ being an integer equal to or greater than 1, and a remainder is R₂, R₂ being a value equal to or greater than 0, the image division section divides the second image into Q₂ second divided images, each of which has a length of L, and one second residual image having a length of R₂ in a long side direction of the second image when R₂ is greater than 0, and
the print instruction transmitting section generates the print data for disposing the Q₁ first divided images in Q₁ print areas, respectively, disposing the Q₂ second divided images in Q₂ print areas, respectively, and disposing the first residual image and the second residual image in one print area for printing when a sum of a length of the first residual image in the long side direction of the first image and a length of the second residual image in the long side direction of the second image is equal to or less than L, and transmits an instruction to print the print data to the printing device.

8. The print control device according to claim 1, further comprising:
a preview display section that generates a preview image in which the plurality of divided images are disposed in the plurality of print areas, respectively, and displays the preview image on a screen of a chat application in the terminal device, wherein
the print instruction transmitting section transmits an instruction to print the print data to the printing device when the print instruction is acquired from the terminal device after the preview image is displayed.

9. A print control method executed in a print control device, the print control method comprising:
causing an image acquisition section to acquire image data to be printed from a terminal device;
causing, when a size of an image indicated by the image data is larger than a size of a print area in one page of a print medium, an image division section to divide the image into a plurality of divided images based on the size of the print area; and
causing a print instruction transmitting section to generate print data for disposing the plurality of divided images in a plurality of the print areas, respectively, for printing and to transmit an instruction to print the print data to a printing device.

10. A printing system comprising:
a print control device; and
a printing device, wherein
the print control device includes
an image acquisition section that acquires image data to be printed from a terminal device,
an image division section that, when a size of an image indicated by the image data is larger than a size of a print area in one page of a print medium, divides the image into a plurality of divided images based on the size of the print area, and
a print instruction transmitting section that generates print data for disposing the plurality of divided images in a plurality of the print areas, respectively, for printing and transmits an instruction to print the print data to the printing device, and
the printing device performs printing based on the print data.
